(19) United States
(12) Patent Application Publication
(10) Pub. No.: US 2012/0133862 A1
(43) Pub. Date: May 31, 2012

(54) LIGHT DIFFUSER FILM AND LIQUID CRYSTAL DISPLAY PANEL USING THE SAME

(76) Inventors: Jin Hui CHO, Uiwang-si (KR); Sung Kook KIM, Uiwang-si (KR); Jin Woo LEE, Uiwang-si (KR); Cheol Ho KIM, Uiwang-si (KR); Sung Eun LEE, Uiwang-si (KR); Sun Hong PARK, Uiwang-si (KR)

(21) Appl. No.: 13/300,747

(22) Filed: Nov. 21, 2011

(30) Foreign Application Priority Data
Nov. 26, 2010 (KR) 10-2010-0118604

(51) Int. Cl. G02F 1/1335; B32B 3/30; G09F 13/04

(52) U.S. Cl. 349/64; 362/602; 428/141

(57) ABSTRACT

The present invention discloses a light diffuser film including a transparent thermoplastic resin, the light diffuser film having an embossed pattern on at least one side thereof, the embossed pattern having an average roughness (Ra) of about 1.5 μm or less, and a peak count (Rpc) of about 100 peaks/cm or more.

### BACKGROUND

1. Field

The present embodiments relate to a light diffuser film and liquid crystal display panel using the same.

2. Description of the Related Art

Liquid crystal displays (LCDs) are widely used for various applications, including televisions, notebook computers, personal computers, and the like, due to their various advantages such as low power consumption enabling operation with a battery for hours, occupation of small space, light weight, and the like.

Display apparatuses, such as an LCD, generally include a diffuser film, which is used to transmit or diffuse light from a backlight unit.

### SUMMARY

One or more embodiments may provide a light diffuser film including a transparent thermoplastic resin, the light diffuser film having an embossed pattern on at least one side thereof, wherein the embossed pattern has an average roughness (Ra) of about 1.5 μm or less and a peak count (Rpc) of about 100 peaks/cm or more.

The light diffuser film may have an Ra of about 0.80 to about 1.5 μm and an Rpc of about 100 to about 300 peaks/cm. The light diffuser film may have an Rt of about 7 to about 16 μm. The light diffuser film may have a monolithic structure. The light diffuser film may not include beads or particles.

The transparent thermoplastic resin may include at least one of a polycarbonate resin, a (meth)acrylate resin, an aromatic vinyl resin, a polyester resin, a cycloolefin resin, an olefin resin, and a polysulfone resin.

The light diffuser film may have a thickness of about 15 to about 450 μm.

The light diffuser film may be on at least one side of a DBEF.

The embossed pattern of the light diffuser film may be formed through extrusion.

One or more embodiments may provide a backlight unit including the light diffuser film. One or more embodiments may provide a liquid crystal display (LCD) including the light diffuser film.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a structure of a general liquid crystal display (LCD);

FIG. 2 illustrates a graph based on which Ra may be determined;

FIG. 3(a) illustrates a cross-sectional view of a surface profile of a conventional light diffuser film;

FIG. 3(b) illustrates a cross-sectional view of a surface profile of a light diffuser film according to one embodiment;

FIG. 4 illustrates a graph based on which Rpc may be determined;

FIG. 5 illustrates a cross-sectional view of light diffuser films stacked on a dual brightness enhancement film (DBEF) according to one embodiment; and

FIG. 6 illustrates a schematic diagram of stages in a film manufacturing process according to one embodiment.

### DETAILED DESCRIPTION

Korean Patent Application No. 10-2010-0118604, filed on Nov. 26, 2010, in the Korean Intellectual Property Office, and entitled: “Light Diffuser Film and Liquid Crystal Display Panel Using the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

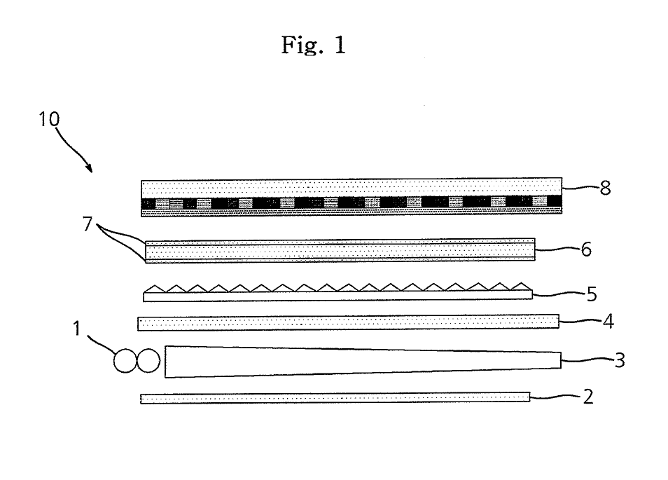

One or more embodiments may provide a light diffuser film 7. The light diffuser film may be used in an LCD 10. As shown in FIG. 1, the LCD 10 may include a backlight unit and a display unit disposed above the backlight unit. The backlight unit may include a light source 1, a light guide plate 3 (to guide light from the light source to the display unit 8), and a reflective plate 2 disposed under the light guide plate 3 (to reflect light leaking from the light guide plate 3 back to the light guide plate 3). A plurality of optical sheets may be disposed above the light guide plate 3 to improve efficiency of light exiting from the light guide plate 3. The optical sheets may include a diffuser sheet 4 and may further include a prism sheet (not shown) and a protective sheet (not shown). In addition, a brightness enhancement film (BEF) 5 and a dual brightness enhancement film (DBEF) 6 may be disposed on the diffuser sheet 4. The DBEF 6 may serve to reflect light, which is reflected and leaks among light entering the display unit from the light source 1 back to the display unit 8. In other words, the DBEF 6 may prevent light loss to improve luminescence efficiency. The light diffuser film 7 may be on one or more sides of the DBEF 6. For example, one light diffuser film 7 may be disposed on each of opposing sides of the DBEF 6, as shown in FIG. 1.

The light diffuser film 7 may be formed of a transparent thermoplastic resin and may have an embossed pattern on at least one side thereof. The embossed pattern may have an average roughness (Ra) of about 1.5 μm or less and a peak count (Rpc) of about 100 peaks/cm or more. Ra may refer to an average roughness value, which is measured using a surface roughness tester and is calculated by the following equation.

$${R}_{a} = \frac{1}{L} {\int }_{x = 0}^{x = L} \vert y \vert d x$$

L: Sample length, y: ordinate of the profile curve

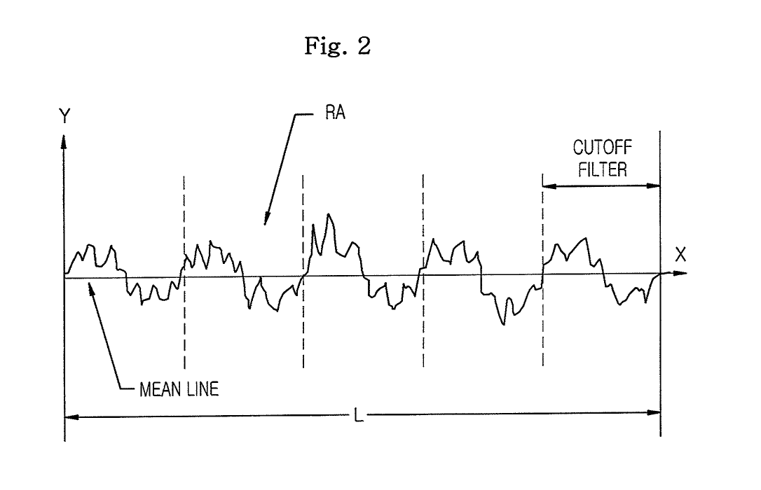

FIG. 2 illustrates a graph based on which Ra may be determined.

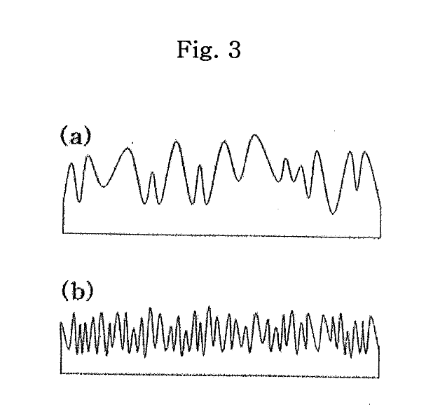

FIG. 3(a) illustrates a cross-sectional view of a surface profile of a conventional light diffuser film, and FIG. 3(b) illustrates a cross-sectional view of a surface profile of a light diffuser film according to one embodiment. The light diffuser films of FIG. 3(a) and FIG. 3(b) have the same Ra value, which does not mean that they have the same roughness. When roughness is evaluated based on Ra only, different peaks and valleys are not reflected. Thus, there are limitations in realizing or reproducing roughness using an Ra value only.

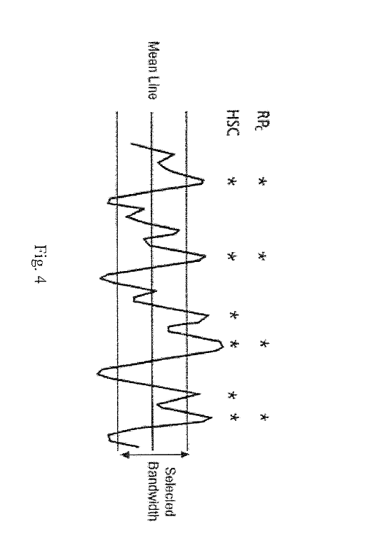

According to embodiments, roughness may be evaluated based on both an Ra value and a peak count (Rpc), obtained by counting the number of peaks which exceed a bandwidth on a mean line. Rpc may be measured using a surface roughness tester. FIG. 4 illustrates a graph based on which Rpc may be determined.

The embossed pattern may have an Ra of about 1.5 μm or less and an Rpc of about 100 peaks/cm. For example, the embossed pattern may have an Ra of about 0.8 to about 1.5 μm and an Rpc of about 100 to about 300 peaks/cm. Within this range, a sparkling phenomenon may be reduced and/or prevented. In one embodiment, Ra may be about 0.85 to about 1.35 μm and Rpc may be about 110 to about 250 peaks/cm. For example, Ra may be about 0.86 to about 1.30 μm and Rpc may be about 115 to about 230 peaks/cm.

Further, the light diffuser film may have an Rt of about 7 to about 16 μm. Within this range, excellent effects of preventing sparkling occurrence and brightness decrease may be obtained. In an implementation, Rt may be about 7.5 to about 15 μm, e.g., about 7.6 to about 12 μm or about 7.7 to about 10 Rt may be defined as a distance between a highest peak and a lowest valley and may be measured using a surface roughness tester.

In one embodiment, the embossed pattern may be a regular and uniform pattern.

In another embodiment, the embossed pattern may be an irregular pattern.

In one embodiment, the light diffuser film may have a monolithic structure. The term “monolithic,” as used herein, means that the light diffuser film may be formed of one element or structure and may not include different elements or structures, such as particles or beads.

As the light diffuser film may not include beads or particles, the light diffuser film may facilitate a favorable production process and may reduce or prevent the sparkling phenomenon, without brightness reduction.

The transparent thermoplastic resin of the light diffuser film may not be particularly limited and may include any resin having transparency. Examples of the transparent thermoplastic resin may include, a polycarbonate resin, a (meth)acrylate resin, an aromatic vinyl resin, a polyester resin, a cycloolefin resin, an olefin resin, a polysulfone resin, and the like. These transparent thermoplastic resins may be used alone or as mixtures. In an implementation, a polycarbonate resin may be used.

The light diffuser film may be a single layer or a multilayer of at least two stacked layers. In any case, the light diffuser film may have a thickness of about 15 to about 450 μm, e.g., about 50 to about 350 μM, or about 100 to about 250

Further, the light diffuser film may have a brightness of about 19,000 nit or more, e.g., about 19,200 nit or more, or about 19,500 to about 22,000 nit.

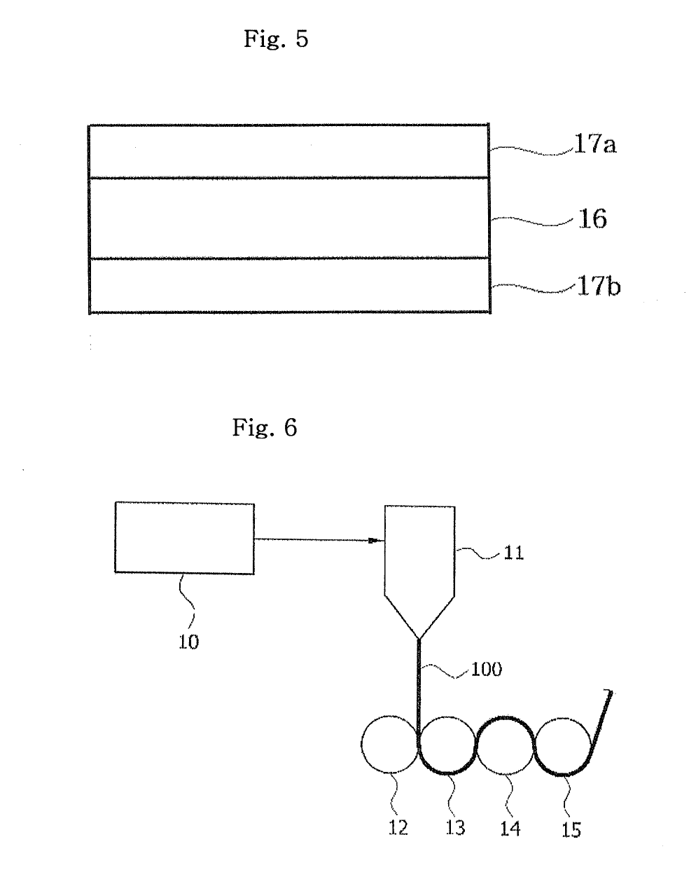

In one embodiment, the light diffuser film may be formed on at least one side of a dual brightness enhancement film (DBEF). FIG. 5 illustrates a cross-sectional view of the light diffuser films 17a, 17b. The light diffuser film 17a may be on the DBEF 16 and the light diffuser film 17b may be under the DBEF 16, according to one embodiment, as shown in FIG. 5. For example, the light diffuser films 17a, 17b may be on opposite sides of the DBEF 16. Further, although not shown in FIG. 5, each of the light diffuser films 17a, 17b may be on either side of the DBEF 16. The light diffuser films 17a, 17b may be disposed on opposite sides of the DBEF 16 by any suitable method, e.g., using a bonding layer.

In another embodiment, the light diffuser film itself may include the DBEF.

The embossed pattern of the light diffuser film may be formed by extrusion. In one embodiment, the embossed pattern may be formed by adjusting pressure between rolls during extrusion. In another embodiment, the embossed pattern may be formed by adjusting roughness of a cooling roll.

FIG. 6 illustrates a schematic diagram of a stage in a film manufacturing process according to one embodiment. In one embodiment, a thermoplastic resin pellet may be melted via an extruder 10, and the melted resin may be discharged into a film 100 via a T-die 11. The film 100 may be cooled while being sequentially brought into contact with cooling rolls 12, 13, 14, 15 on the outside of the T-die 11. The cooling rolls 12, 13, 14, 15 may be disposed adjacent to each other at predetermined intervals and rotate at a constant speed. Although the number of cooling rolls is not particularly limited. In an implementation, 2 to 5 cooling rolls may be used. A distance between the T-die 11 and the cooling rolls 12, 13, 14, 15 and the rotation speeds of the cooling rolls 13, 14, 15 may be conveniently set and adjusted by those skilled in the art. The extruder and the T-die may have heaters to adjust a temperature of regions. According to some embodiments, the cooling roll 13 may have an embossed pattern. The embossed pattern of the cooling roll 13 may have a shape that is a reverse of a shape of the embossed pattern of the film. According to some embodiments, the cooling roll 12 may have an embossed pattern. According to some embodiments, the cooling roll 14 may have an embossed pattern.

Referring back to FIG. 1, one or more embodiments may include the LCD 10 including the light diffuser film 7. According to some embodiments, the light diffuser film 7 may be formed on the diffuser sheet 4. According to some embodiments, the light diffuser film 7 may be formed on the brightness enhancement film (BEF) 6. According to some embodiments, the light diffuser film may be formed on an upper and/or lower side, e.g., opposite sides, of the DBEF. One or more embodiments may include the backlight unit including the light diffuser film 7. The backlight unit may include the light source 1, the light guide plate 3 for guiding light from the light source to the display unit 8, and the light diffuser film 7 formed on the light guide plate.

The following Examples and Comparative Examples are provided in order to set forth particular details of one or more embodiments. However, it will be understood that the embodiments are not limited to the particular details described. Further, the Comparative Examples are set forth to highlight certain characteristics of certain embodiments, and are not to be construed as either limiting the scope of the invention as exemplified in the Examples or as necessarily being outside the scope of the invention in every respect.

A description of details apparent to those skilled in the art will be omitted herein.

### EXAMPLES

### Examples 1-6

A film was prepared using a molding machine equipped with the extruder 10, the T-die 11, and the cooling rolls 12, 13, 14, and 15 shown schematically in FIG. 6. The T die 11 had a width of 600 mm, and a first cooling roll, a second cooling roll, and a third cooling roll were a rubber roll 12, an embossing roll 13, and an untreated steel roll 14, respectively. A polycarbonate resin (PC SC1190 grade, Mw=21,000 g/mol, Cheil Industries Inc.) was extruded at a discharge rate of 23.4 kg/hr using the T die set to 290° C. Here, the first cooling roll, the second cooling roll, and the third cooling roll had a temperature set to 90° C., 110° C., and 130° C., respectively. While adjusting the roughness of the embossing roll 13, PC diffuser films were manufactured to have Ra, Rpc, and Rt values as listed in Table 1, and results are illustrated in Table 1.

### Comparative Examples 1 to 6

PC diffuser films were manufactured in the same manner as in Example 1 except that Ra, Rpc, and Rt values were changed as listed in Table 1.

### Comparative Examples 7 and 8

A PC (Cheil SC 1190) diffuser film including 3 wt % of 20 μm PMMA beads was used in Comparative Example 7. A PC (Cheil SC 1190) diffuser film including 5 wt % of 10 μm PMMA beads was used in Comparative Example 8.

TABLE 1

| | | | RPc | | | |
|---|---|---|---|---|---|---|
| | | | (Peak | Rt | | |
| | | Ra (μm) | No./cm) | (μm) | Sparkling | Brightness (nit) |
| Example | 1 | 1.15 | 120 | 8.9 | None | 19600 |
| | 2 | 1.20 | 140 | 9.2 | None | 19550 |
| | 3 | 1.13 | 160 | 8.5 | None | 19550 |
| | 4 | 0.87 | 180 | 7.8 | None | 19600 |
| | 5 | 1.05 | 200 | 8.2 | None | 19620 |
| | 6 | 1.23 | 120 | 15.7 | None | 19200 |
| Comparative | 1 | 1.92 | 50 | 16.3 | Appear | 18900 |
| Example | 2 | 1.74 | 60 | 17.5 | Appear | 19000 |
| | 3 | 1.79 | 70 | 18.2 | Appear | 19120 |
| | 4 | 1.81 | 80 | 18.1 | Appear | 19100 |
| | 5 | 0.74 | 80 | 6.2 | Appear | 18400 |
| | 6 | 1.76 | 120 | 18.5 | Appear | 18600 |

| | | | | |
|---|---|---|---|---|
| 7 | PC substrate + | 6.4 | None | 18940 |
| | 20 μm Bead | | | |
| 8 | PC substrate + | 5.9 | None | 19050 |
| | 10 μm Bead | | | |

Evaluation Methods of Physical Properties

Surface roughness (Ra, Rpc, Rt)

Surface roughness was measured using a surface roughness tester, Mitutoyo SJ-201.

(2) Sparkling Phenomenon

Each film was disposed on a TV screen and then observed with the naked eye.

None: Sparkling phenomenon does not appear

Appear: Sparkling phenomenon appear

(3) Brightness

Brightness was measured using ELDIM EZ Contrast X88RC.

As shown in Table 1, the light diffuser films having a low Ra and a high Rpc according to Examples 1 to 6 did not exhibit a sparkling phenomenon and maintained high brightness. On the contrary, the light diffuser films having a high Ra and a low Rpc according to Comparative Examples 1 to 4 exhibited a sparkling phenomenon. The light diffuser film having a low Ra and a low Rpc according to Comparative Example 5 and the light diffuser film having a high Ra and a high Rpc according to Comparative Example 6 also exhibited a sparkling phenomenon and had brightness reduction. The light diffuser films including beads according to Comparative Examples 7 and 8 hardly exhibited a sparkling phenomenon but had remarkable brightness decrease.

By way of summation and review, an LCD generally includes an embossed pattern formed on at least one side of a DBEF film, or a protective film having an embossed pattern is stacked on one side of the DBEF film. Conventionally, the embossed pattern used for the DBEF film has a similar pitch to a pixel, thereby causing a sparkling problem due to collection of light. As transmittance is increased to enhance brightness with wide use of LED BLU TVs, a sparkling phenomenon becomes an issue. Using a diffuser film including beads instead of using a conventional embossed film brings about an adverse effect of decreasing brightness. Furthermore, such beads can be broken during processing and complicate a manufacturing process, resulting in product price increase.

In contrast, one or more embodiments may provide a light diffuser film which does not cause a sparkling phenomenon in an LED BLU TV and does not include beads. For example, one or more embodiments provide a light diffuser film having surface roughness, which is controlled to resolve a sparkling problem that may occur on part of a final panel. The light diffuser film according to embodiments may not require beads to prevent brightness reduction, thereby facilitating a manufacturing process. The light diffuser film according to embodiments may be particularly suitable for a protective film of a dual brightness enhancement film (DBEF) of an LED BLU TV. One or more embodiments provide a backlight unit including the light diffuser film, which may prevent brightness reduction and avoid a sparkling problem.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A light diffuser film comprising a transparent thermoplastic resin, the light diffuser film having an embossed pattern on at least one side thereof, wherein the embossed pattern has an average roughness (Ra) of about 1.5 μm or less and a peak count (Rpc) of about 100 peaks/cm or more.

2. The light diffuser film as claimed in claim 1, wherein the light diffuser film has an Ra of about 0.8 to about 1.5 μm and an Rpc of about 100 to about 300 peaks/cm.

3. The light diffuser film as claimed in claim 1, wherein the light diffuser film has an Rt of about 7 to about 16 μm.

4. The light diffuser film as claimed in claim 1, wherein the light diffuser film has a monolithic structure.

5. The light diffuser film as claimed in claim 4, wherein the light diffuser film does not include beads or particles.

6. The light diffuser film as claimed in claim 1, wherein the transparent thermoplastic resin includes at least one of a polycarbonate resin, a (meth)acrylate resin, an aromatic vinyl resin, a polyester resin, a cycloolefin resin, an olefin resin, and a polysulfone resin.

7. The light diffuser film as claimed in claim 1, wherein the light diffuser film has a thickness of about 15 to about 450 μm.

8. The light diffuser film as claimed in claim 1, wherein the light diffuser film is on at least one side of a dual brightness enhancement film (DBEF).

9. The light diffuser film of claim 1, wherein the embossed pattern of the light diffuser film is formed through extrusion.

10. A backlight unit including the light diffuser film as claimed in claim 1.

11. A liquid crystal display (LCD) including the light diffuser film as claimed in claim 1.
